(19) United States
(12) Patent Application Publication
(10) Pub. No.: US 2018/0046679 A1
(43) Pub. Date: Feb. 15, 2018

(54) EFFICIENT INTEGRATION OF DE-IDENTIFIED RECORDS

(71) Applicant: KONINKLIJKE PHILIPS N.V, EINDHOVEN (NL)

(72) Inventors: REZA SHARIFI SEDEH, MALDEN, MA (US); DANIEL ROBERT ELGORT, NEW YORK, NY (US); MIN XUE, BRIARCLIFF MANOR, NY (US)

(21) Appl. No.: 15/551,429

(22) PCT Filed: Feb. 27, 2016
(86) PCT No.: PCT/IB2016/051094

§ 371 Date: Aug. 16, 2017

Related U.S. Application Data
(60) Provisional application No. 62/121,608, filed on Feb. 27, 2015.

(51) Int. Cl. G06F 17/30; G06Q 50/24; G06F 19/00

(52) U.S. Cl. CPC G06F 17/30528; G06F 19/322; G06F 17/30342; G06Q 50/24

(57) ABSTRACT

A method includes retrieving de-identified records for individuals from at least two different databases. Each of the databases stores a different type of information for the individuals. The method further includes identifying a set of features common across the at least two different databases. The method further includes generating a unique identification for each of the individuals in the retrieved de-identified records based on the set of features. The method further includes computing a rarity coefficient for each of the individuals based on the set of features. The method further includes matching the de-identified entities across the at least two different databases based on the rarity coefficients. The method further includes matching the de-identified patient records for a set of matched de-identified entities. The method further includes constructing a database with one or more sets of the matched de-identified records.

### FIELD OF THE INVENTION

The following generally relates to the integration of de-identified records and more particularly to a record-level integration of de-identified records of de-identified entities across databases that store different types of information.

### BACKGROUND OF THE INVENTION

Various types of databases from administrative, to operational, to clinical, etc. exist. These databases have been used separately by researchers to approach their domain-specific research problems—i.e., administration, operations, or clinics. If integrated, these databases would provide richer and more beneficial information for use in healthcare services, solutions research, etc., and would facilitate doing research on a broader range of research projects, which are not limited only to one specific domain. For privacy, the records in such databases, as well as the source entities of the records, have been de-identified.

However, when these databases are available only with de-identified information (i.e., all references to names of individuals and/or the source entities are removed), there is no straight-forward approach available to match patient records across the different databases. To match corresponding records across these databases and construct an integrated data set, the records have to be matched based on a set of non-uniquely identifying features (e.g. age, sex, weight, key diagnosis, length of hospital stay, etc.). Unfortunately, this can be a tedious and time consuming task, requiring processing of large volumes of information with the matching prone to error.

### SUMMARY OF THE INVENTION

Aspects of the present application address the above-referenced matters and others.

According to one aspect, a method includes retrieving de-identified records for individuals from at least two different databases. Each of the databases stores a different type of information for the individuals. The method further includes identifying a set of features common across the at least two different databases. The method further includes generating a unique identification for each of the individuals in the retrieved de-identified records based on the set of features. The method further includes computing a rarity coefficient for each of the individuals based on the set of features. The method further includes matching the de-identified entities across the at least two different databases based on the rarity coefficients. The method further includes matching the de-identified patient records for a set of matched de-identified entities. The method further includes constructing a database with one or more sets of the matched de-identified records.

In another aspect, a computing system includes a memory device configured to store instructions, including a record integration module and a processor that executes the instructions, which causes the processor to: match de-identified entities across different databases using rare individuals; and match de-identified records for only the matched de-identified entities.

In another aspect, a computer readable storage medium is encoded with computer readable instructions, which, when executed by a processor of a computing system, causes the processor to: retrieve de-identified records for individuals from at least two different databases, each database storing a different type of information for the individuals, identify a set of features common across the at least two different databases, generate a unique identification for each de-identified individual in the retrieved de-identified records based on the set of features, compute a rarity coefficient for each of the de-identified patients based on the set of features, match the de-identified entities across the at least two different databases based on the rarity coefficients, and match the de-identified patient records for a set of matched de-identified entities.

Still further aspects of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example system that includes a computing system with a record integration module in communication with multiple databases storing different types of de-identified records.

FIG. 2 schematically illustrates an example the record integration module.

FIG. 3 illustrates an example method for record-level integration of de-identified records of de-identified entities across databases storing different types of information.

### DETAILED DESCRIPTION OF EMBODIMENTS

The following describes an approach to integrating de-identified records, of de-identified source entities, which are located in a plurality of different databases, each database storing a different type of information.

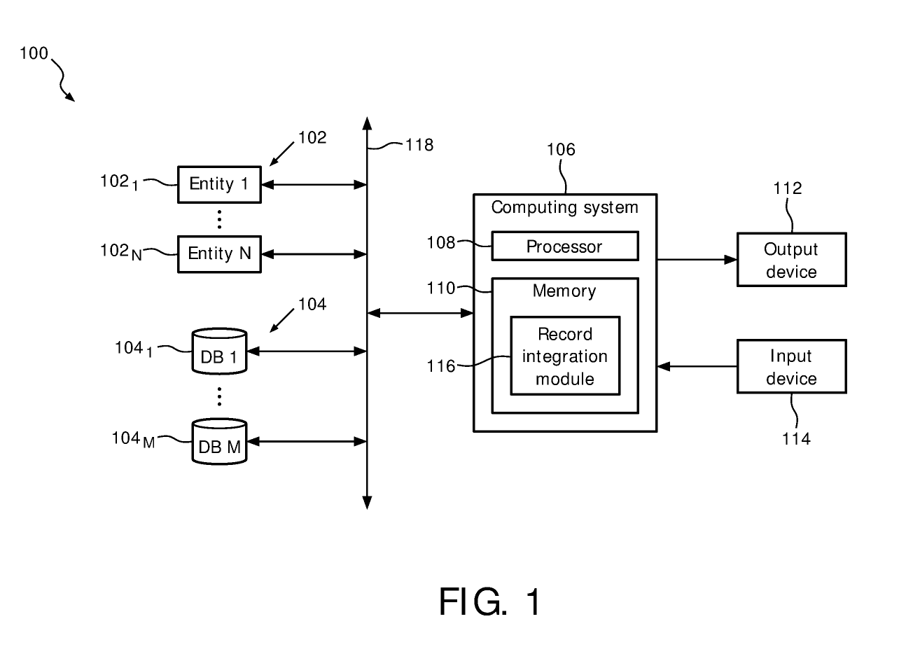

FIG. 1 illustrates a system 100.

The system 100 includes a plurality of entities 102₁, . . . 102_{N} (collectively referred to as entities 102), where N is a positive integer greater than two (2). An entity 102, e.g., is a hospital, a clinic, a doctor's office, a commercial business, etc. Each entity 102 produces one or more different types of information for an individual (e.g., a patient in the context of a healthcare entity). A type of information, e.g., is administrative, operational, clinical, claims, and/or other types of information.

Each entity 102, in general, employs its own unique identification generating algorithm for creating and assigning an internal (i.e., within the entity 102) identifier for each individual of the entity 102. The information for an individual within the entity 102 is grouped together, labelled and linked with the identifier for that individual. Typically, no two entities 102 utilize the exact same algorithm. Thus, information for a same individual at two different entities is likely to be assigned different identities and cannot be readily matched.

The system further includes a plurality of databases 104₁, . . . , 104_{M} (collectively referred to as databases 104), where M is a positive integer equal to or greater than two (2). Each database 104 stores a particular type of the information, which is different from a type of information stored in another database 104. For example, one database 104 may store only clinical information while another database 104 stored only claims information. The information stored in each of the databases 104 is de-identified data in that all references to names of individuals and entities are removed.

A computing system 106 includes at least one processor 108 (e.g., a microprocessor, a central processing unit, etc.) that executes at least one computer readable instruction stored in computer readable storage medium (“memory”) 110, which excludes transitory medium and includes physical memory and/or other non-transitory medium. The computing system 106 further includes an output device(s) 112 such as a display monitor and an input device(s) 114 such as a mouse, keyboard, etc. The at least one computer readable instruction, in this example, includes a record integration module 116.

As described in greater detail below, the instructions of the record integration module 116, when executed by the at least one processor 108, cause the at least one processor 108 to integrate at least a subset of the de-identified records in the databases 104. The integrated data set provides more information about an individual relative to the individual databases. In one instance, the integrated data is well-suited for use in services such as healthcare and solutions research, and may facilitate research on a broader range of research projects, such as the simultaneous analysis of cost (from a “claims” database) and quality of care (from a “clinical” database) for an individual.

In the illustrated example, the entities 102, the databases 104 and the computing system 106 are all in communication with a network 118.

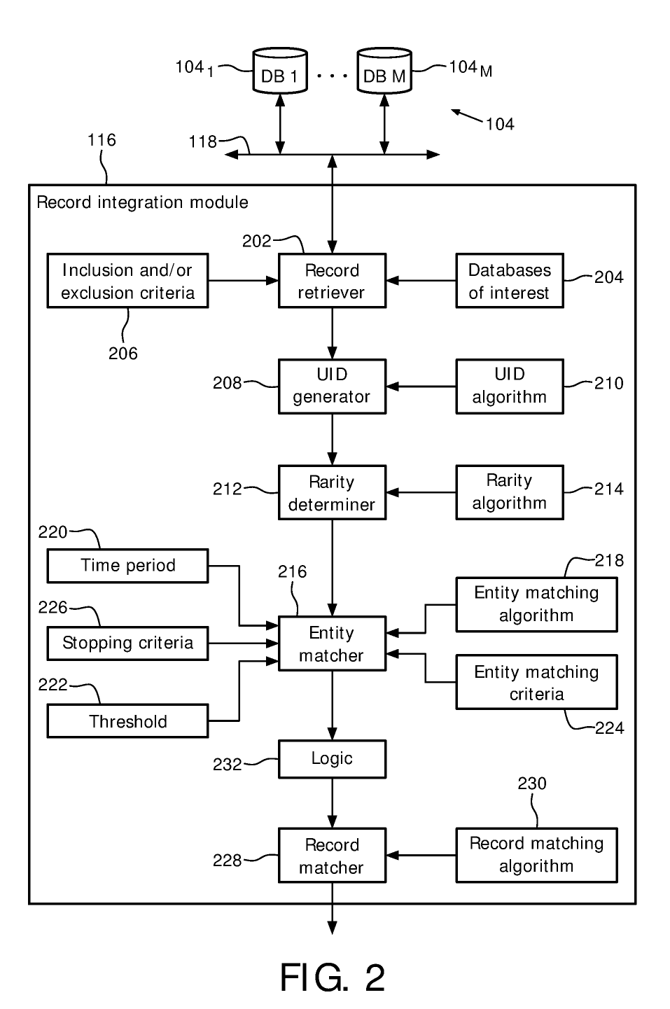

FIG. 2 schematically illustrates an example of the record integration module 116.

The record integration module 116 includes a record retriever 202. The record retriever 202 retrieves records from the databases 104 for integration. In this example, the record retriever 202 retrieves records under constraints of a set of databases of interest 204 and inclusion and/or exclusion criteria 206. The set of databases of interest 204 indicates source databases (e.g., a “clinical” database 104ᵢ and a “claims” database 104ⱼ). The inclusion and/or exclusion criteria 206 indicate a subset of records to retrieve.

By way of non-limiting example, where the databases 104 being accessed are the “clinical” database 104ᵢ, with only includes patient records of ICU patients, and the “claims” database 104ⱼ, which includes patient records for ICU patients and other patients, the inclusion and/or exclusion criteria 206 may constrain the record retriever 202 so that it retrieves the patient records from the “clinical” database 104ᵢ and only the patient records of patients admitted to the ICU from the “claims” database 104ⱼ. As a result, the record retriever 202 may retrieve only a subset of records from the databases 104.

The record integration module 116 further includes unique identifier (UID) generator 208. The UID generator 208 generates a UID for each de-identified individual in the retrieved records. The UIDs can be stored in the memory 110 of the computing system 106, in one or more of the databases 104, and/or in another storage device(s). In this example, the UID generator 208 generates UIDs based on a UID algorithm 210, which utilizes common patient features of the databases 104. Examples of common patient features include: age, race, mortality, gender, hospital length of stay (LOS), hospital discharge location (DL), admission source (AS), diagnosis and/or other features.

By way of non-limiting example, in one instance the UID algorithm 210 defines the following numeric coding scheme based on age, race, gender, mortality and LOS. A first set of digits (“X”xxxxxx) represents gender. In this example, a value of 1 indicates male, and a value of 0 indicates female. A second set of digits (x“X”xxxxx) represents race. In this example, a value of 5 represents race A. A third set of digits (xx“X”xxxx) represents mortality. In this example, a value of 1 indicates the patient is not alive, and a value of 0 indicates the patient is alive. A fourth set of digits (xxx“XXX”xx) represents LOS. A fifth set of digits (xxxxx“XX”) represents age. Other common patient features and/or coding (e.g., alpha, alphanumeric, etc.) schemes are contemplated herein.

Thus, for a patient record with the following common patient features: gender=male, race=A, mortality=not alive, LOS=122 days, and age=18 years old, the UID generator 208 generates the following UID: 15112218. Since age and LOS are numeric values and can be rounded up or down in different electronic record systems, a tolerance (e.g., of ±1 or other), in one instance, is used when generating a UID. That is, the patient in the above example could be anywhere from seventeen and half years old to eighteen and half years old. Similarly, the patient may have been discharged some time during the one hundred and twenty-second day, resulting in a LOS of 121 or 122 days, depending on whether the discharge day counts as a full day.

The record integration module 116 further includes a rarity determiner 212 that computes a rarity coefficient for each de-identified individual in the records from the databases 104 being processed based on a rarity algorithm 214. An example rarity coefficient for the example patient UID=15112218, using the rarity algorithm 214, is computed as shown Table 1.

TABLE 1
Example Rarity Coefficient Calculation for Patient UID = 15112218.

| | | | | | Rarity |
|---|---|---|---|---|---|
| Gender (A) | Race (B) | Mortality (C) | LOS (D) | Age (E) | Coefficient |
| % male | % race A | % not alive | % >=122 days | % <=18 | A * B * C * D * E |
| 45.00% | 0.10% | 0.00% | 0.01% | 1.00% | 4.5 × 10⁻¹¹ |

From Table 1, the rarity coefficient for the example patient UID=15112218 is 4.5*10⁻¹¹, which means approximately, in every 22 billion patients, there is only one patient with a rarity coefficient as small as this patient's rarity coefficient. In general, the lower the rarity coefficients, the rarer the patient is in the database. Other rarity algorithms are also contemplated herein.

The record integration module 116 further includes an entity matcher 216 that matches the de-identified entities across the databases 104 based on an iterative entity matching algorithm 218. By way of example, for a particular time period 220 (e.g., a particular year) and a first iteration, the entity matcher 216, for individuals of a first de-identified entity of a first database that have a rarity coefficient less than a predetermined threshold 222, matches these individuals with individuals of a de-identified entity in a different database.

In one instance, the matching is achieved as follows. If the second de-identified entity is associated with records of at least X (e.g., 3, 4, 5, 6, . . . , 10) of the records of the first de-identified entity and Y percent (e.g., 20%, 23%, 30%, 39%, etc.) of the total number of records of the first de-identified entity, the match is deemed successful. If a match is successful, the entity matcher 216 links the de-identified entities together and excludes them from entity matching during a subsequent iteration.

For a subsequent iteration, the threshold 222 is increased by a predetermined amount (e.g., by a factor of 2, 5, 10, 13, etc.), and the entity matching algorithm 218 is executed again. Stopping criteria 226 for the present iteration, in one instance, includes the linking all of the entities across the databases 104. Once the stopping criterion is reached, entity matching can be performed again for one or more other time periods.

For example, the above can be repeated for all or a subset of the years represented in the records. Where the above is repeated for all or a subset of the years represented in the records, logic 232 combines the results for the different years. If two de-identified entities are matched over a predetermined number of the years, the logic 232 confirms the two de-identified entities are the same entity and generates a signal indicative thereof.

The record integration module 116 further includes a record matcher 228 that matches de-identified records across the databases 104 for each set of matched entities based on a record matching algorithm 230. In one instance, the matching is achieved as follows. If a de-identified individual A has the same UID as a de-identified individual B and the de-identified individual A and the de-identified individual B share at least 50% of the same diagnosis codes of the individual (i.e., A or B) with the least number of diagnosis codes, the record matcher 228 deems the match successful. Other algorithms are also contemplated herein.

The resulting integrated data set can be used to construct a database with one or more sets of the matched de-identified patient records. In general, the above describes a hierarchical record level integration approach in which de-identified entities are first matched across databases using rare individual in the databases and then de-identified record matching is performed only on the de-identified records of the databases that are from the same de-identified entity.

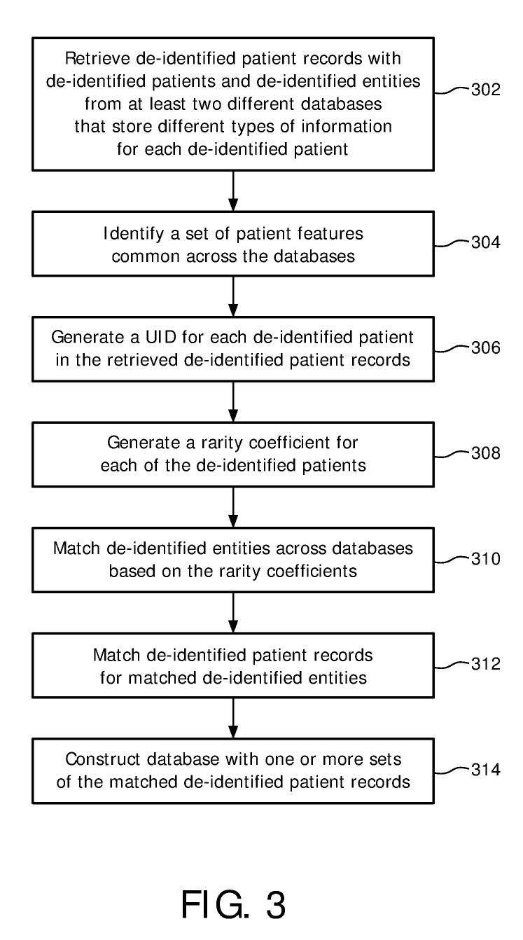

FIG. 3 illustrates an example method for record-level integration of de-identified records of de-identified entities across databases storing different types of information.

It is to be appreciated that the ordering of the acts in the methods described herein is not limiting. As such, other orderings are contemplated herein. In addition, one or more acts may be omitted and/or one or more additional acts may be included.

For explanatory purposes, this method is described in connection with individual who are patients and entities which are healthcare facility. However, as described herein, other individual and entities are contemplated herein.

At 302, de-identified patient records (with de-identified patients and de-identified entities) from at least two different databases (which store different types of information for each patient) are retrieved, as described herein and/or otherwise.

As discussed herein, in one instance inclusion and/or exclusion criteria are used to distinguish and extract only one or more relevant subsets of patient records from at least two different databases.

At 304, a set of features common across the at least two different databases is identified, as described herein and/or otherwise.

At 306, a UID is generated for each de-identified patient in the retrieved de-identified patient records using the set of patient features, as described herein and/or otherwise.

At 308, a rarity coefficient is generated for each of the de-identified patients using the set of patient features, as described herein and/or otherwise.

At 310, de-identified entities are matched across the at least two different databases based on the rarity coefficients, as described herein and/or otherwise.

At 312, de-identified patient records for matched de-identified entities are matched between de-identified patients.

At 314, a database is constructed with one or more sets of the matched de-identified patient records.

The above may be implemented by way of computer readable instructions, which when executed by a computer processor(s), cause the processor(s) to carry out the described acts. In such a case, the instructions can be stored in a computer readable storage medium associated with or otherwise accessible to the relevant computer. Additionally or alternatively, one or more of the instructions can be carried by a carrier wave or signal.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

1. A method, comprising:
retrieving de-identified records for individuals from at least two different databases, each of the at least two databases storing a different type of information for the individuals;
identifying a set of features common across the at least two different databases;
generating a unique identification for each of the individuals in the retrieved de-identified records based on the set of features;
computing a rarity coefficient for each of the individuals based on the set of features;
matching the de-identified entities across the at least two different databases based on the rarity coefficients;
matching the de-identified patient records for a set of matched de-identified entities; and
constructing a database with one or more sets of the matched de-identified records.

2. The method of claim 1, wherein the de-identified records include records without identities of the individuals and without identities of the information source entities.

3. The method of claim 2, wherein the de-identified individuals include patients and the de-identified information source entities include healthcare facilities.

4. The method of a claim 1, wherein the type of sources include two or more of administrative, operational, clinical, or claims.

5. The method of claim 1, further comprising:
utilizing inclusion and/or exclusion criteria to identity and retrieve only a subset of the records in the at least two different databases.

6. The method of claim 1, wherein the set of features is selected from a group consisting of: age, race, mortality, gender, hospital length of stay, hospital discharge location, admission source, and diagnosis.

7. The method of claim 1, wherein a unique identification includes a sequence of numeric characters that includes a set of numeric characters for each of the features in the set of features.

8. The method of claim 7, wherein at least one of the sets of numeric characters includes a tolerance.

9. The method of claim 1, further comprising:
determining, for an individual and each feature, a percentage for the individual relative to a population of the individuals, wherein the rarity coefficient for the individual is computed by multiplying the percentages.

10. The method of claim 9, further comprising:
matching individuals from a first database that have a rarity coefficient that is less than a threshold level with individuals in second database; and
identifying two corresponding de-identified entities as a same entity in response to a second of the de-identified entities being associated with a predetermined number of same records of a first the de-identified entities and the second of the de-identified entities having a predetermined percentage of a total number of records of the first of the de-identified entities.

11. The method of claim 10, further comprising:
increasing the threshold level;
matching individuals from the first database that have a rarity coefficient that is less than the increased threshold level with individuals in the second database; and
identifying two de-identified entities as the same identity in response to the second entity being associated with the predetermined number of same records of the first de-identified entity and the second entity having the predetermined percentage of the total number of records of the first de-identified entity.

12. The method of claim 11, further comprising:
matching the de-identified entities using the threshold during a first iteration for a first time period; and
matching the de-identified entities using the increased threshold during a second iteration for the first time period.

13. The method of claim 12, further comprising:
matching the de-identified entities over a plurality of different years; and
confirming two de-identified entities are a same entity in response to the two de-identified entities being matched over a predetermined number of the different years.

14. The method of claim 13, further comprising:
matching two records corresponding respectively corresponding to two matched entities in response to the two records having the same unique identifier and sharing a predetermined number diagnosis codes.

15. A computing system, comprising:
a memory device configured to store instructions, including a record integration module; and
a processor that executes the instructions, which causes the processor to: match de-identified entities across different databases using rare individuals; and match de-identified records for only the matched de-identified entities.

16. The computing system of claim 15, wherein the processor calculates a rarity coefficient for each individual in the records based on a set a set of features common across the different databases and matches the de-identified entities based on the rarity coefficient.

17. The computing system of claim 16, wherein the processor matches de-identified entities corresponding to a common set of records for rare individuals.

18. The computing system of claim 17, wherein the processor matches de-identified records in response to the records having a same unique identifier and sharing a predetermined number diagnosis codes.

19. The computing system of claim 15, wherein the processor employs an iterative record level integration algorithm to match the de-identified entities and to match the de-identified records based thereon.

20. A computer readable storage medium encoded with computer readable instructions, which, when executed by a processor of a computing system, causes the processor to:
retrieve de-identified records for individuals from at least two different databases, each database storing a different type of information for the individuals;
identify a set of features common across the at least two different databases;
generate a unique identification for each de-identified individual in the retrieved de-identified records based on the set of features;
compute a rarity coefficient for each of the de-identified patients based on the set of features;
match the de-identified entities across the at least two different databases based on the rarity coefficients; and
match the de-identified patient records for a set of matched de-identified entities.
